(19) United States
(12) Patent Application Publication
(10) Pub. No.: US 2025/0384807 A1
(43) Pub. Date: Dec. 18, 2025

(54) SWEEP SIGNAL GENERATOR, DISPLAY DEVICE INCLUDING THE SWEEP SIGNAL GENERATOR AND ELECTRONIC DEVICE INCLUDING THE SWEEP SIGNAL GENERATOR

(71) Applicant: Samsung Display Co., Ltd., Yongin-si (KR)

(72) Inventors: TAEGYUN KIM, Yongin-si (KR); MINJAE JEONG, Yongin-si (KR); MINDO HEO, Yongin-si (KR)

(21) Appl. No.: 19/087,329

(22) Filed: Mar. 21, 2025

(30) Foreign Application Priority Data
Jun. 13, 2024 (KR) 10-2024-0076709

(51) Int. Cl. G09G 3/20

(52) U.S. Cl. CPC G09G 3/2007; G09G 2300/0426; G09G 2300/0819; G09G 2300/0852; G09G 2310/08

(57) ABSTRACT

A display device including a display panel including a pixel, and a sweep signal generator, a data driver to apply a pixel data voltage, a sweep data voltage, and a pulse width modulation data voltage, a gate driver to output a write signal, a pulse width modulation write signal, an initialization signal, and a light-emitting element initialization signal, and an emission driver, the pixel including a light-emitting element, a pixel circuit block to apply a driving current in response to the pixel data voltage and the pulse width modulation write signal, and having a structure that is consistent with a structure of the sweep signal generator, and a pulse width modulation block to apply the pulse width modulation write signal to the pixel circuit block based on the pulse width modulation write signal, the sweep signal from the sweep signal generator, and the pulse width modulation data voltage.

### CROSS-REFERENCE TO RELATED APPLICATION

The present application claims priority to, and the benefit of, Korean Patent Application No. 10-2024-0076709, filed on Jun. 13, 2024, in the Korean Intellectual Property Office, the entire disclosure of which is incorporated herein by reference.

### BACKGROUND

### 1. Field

Embodiments of the present disclosure relate to sweep signal generator, a display device including the sweep signal generator, and an electronic device including the sweep signal generator applicable for various electronic apparatuses.

### 2. Description of the Related Art

Generally, a display device includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines, and a driving controller controlling the gate driver, the data driver and the emission driver.

To express a grayscale of the display panel, a pulse width modulation method may be applied. For applying the pulse width modulation method, a sweep signal may be required, and generally, the sweep signal may be generated by an emission driver. Therefore, as the size of the emission driver increases, there is a problem that the dead space of the display device increases.

### SUMMARY

Embodiments of the present disclosure provide a sweep signal generator generating a sweep signal for applying the pulse width modulation method.

Embodiments of the present disclosure also provide a display device including the sweep signal generator.

Embodiments of the present disclosure also provide an electronic device including the sweep signal generator.

According to embodiments, a display device may include a display panel including a pixel, and a sweep signal generator configured to generate a sweep signal, a data driver configured to apply a pixel data voltage, a sweep data voltage, and a pulse width modulation data voltage to the display panel, a gate driver configured to output a write signal, a pulse width modulation write signal, an initialization signal, and a light-emitting element initialization signal, and an emission driver configured to apply an emission signal to the display panel, wherein the pixel includes a light-emitting element, a pixel circuit block configured to apply a driving current to the light-emitting element in response to the pixel data voltage and the pulse width modulation write signal, and having a structure that is consistent with a structure of the sweep signal generator, and a pulse width modulation block configured to apply the pulse width modulation write signal to the pixel circuit block based on the pulse width modulation write signal, the sweep signal from the sweep signal generator, and the pulse width modulation data voltage.

The pixel circuit block may include a first transistor including a control electrode connected to a first node, a first electrode connected to a second node, and a second electrode connected to a third node, a second transistor including a control electrode for receiving the write signal, a first electrode for receiving the pixel data voltage, and a second electrode connected to the second node, and a fifth transistor including a control electrode for receiving the emission signal, a first electrode for receiving a first power voltage, and a second electrode connected to the second node, and wherein the pulse width modulation block includes an eighth transistor including a control electrode connected to a fifth node, a first electrode for receiving the first power voltage, and a second electrode connected to the control electrode of the first transistor, and a ninth transistor including a control electrode for receiving the pulse width modulation write signal, a first electrode for receiving the pulse width modulation data voltage, and a second electrode connected to the fifth node.

The first transistor may include a P-type transistor, and the eighth transistor may include an N-type transistor.

The sweep signal may be configured to be increased from a sweep low level to a sweep high level when the emission signal has an activation level.

The pulse width modulation write signal may include the write signal.

The pulse width modulation block may further include a sweep capacitor connected to the sweep signal generator.

The sweep signal generator may include a tenth transistor configured to apply the first power voltage to the sweep capacitor, an eleventh transistor configured to apply the sweep data voltage to the tenth transistor in response to the write signal, and a fourteenth transistor configured to apply the first power voltage to the tenth transistor in response to the emission signal.

The pixel circuit block may further include a third transistor connected to the first node and the third node, a fourth transistor configured to apply a first initialization voltage to the first transistor in response to the initialization signal, a sixth transistor configured to apply the driving current to the light-emitting element in response to the emission signal, a seventh transistor configured to apply a second initialization voltage to an anode of the light-emitting element in response to the light-emitting element initialization signal, and a first storage capacitor configured to store a voltage of the first node.

The second initialization voltage and the first initialization voltage may be substantially equal.

The eighth transistor may include a control electrode connected to the fifth node, a first electrode for receiving the first power voltage, and a second electrode connected to the control electrode of the first transistor, wherein the ninth transistor includes a control electrode for receiving the pulse width modulation write signal, a first electrode for receiving the pulse width modulation data voltage, and a second electrode connected to the fifth node.

The eighth transistor may include an N-type transistor.

The pixel circuit block may include a first transistor including a control electrode connected to a first node, a first electrode connected to a second node, and a second electrode connected to a third node, a second transistor including a control electrode for receiving the write signal, a first electrode for receiving the pixel data voltage, and a second electrode connected to the second node, a third transistor including a control electrode for receiving the write signal, a first electrode connected to the third node, and a second electrode connected to the first node, a fourth transistor including a control electrode for receiving the initialization signal, a first electrode for receiving a first initialization voltage, and a second electrode connected to the first node, a fifth transistor including a control electrode for receiving the emission signal, a first electrode for receiving a first power voltage, and a second electrode connected to the second node, a sixth transistor including a control electrode for receiving the emission signal, a first electrode connected to the third node, and a second electrode connected to a fourth node, a seventh transistor including a control electrode for receiving the light-emitting element initialization signal, a first electrode for receiving a second initialization voltage, and a second electrode connected to the fourth node, and a first storage capacitor including a first electrode for receiving the first power voltage, and a second electrode connected to the first node, wherein the pulse width modulation block includes an eighth transistor including a control electrode connected to a fifth node, a first electrode for receiving the first power voltage, and a second electrode connected to the first node, a ninth transistor including a control electrode for receiving the pulse width modulation write signal, a first electrode for receiving the pulse width modulation data voltage, and a second electrode connected to the fifth node, and a sweep capacitor including a first electrode connected to the sweep signal generator, and a second electrode connected to the fifth node, and wherein the sweep signal generator includes a tenth transistor including a control electrode connected to a sixth node, a first electrode connected to a seventh node, and a second electrode connected to an eighth node, an eleventh transistor includes a control electrode for receiving the write signal, a first electrode for receiving the sweep data voltage, and a second electrode connected to the seventh node, a twelfth transistor including a control electrode for receiving the write signal, a first electrode connected to the eighth node, and a second electrode connected to the sixth node, a thirteenth transistor including a control electrode for receiving the initialization signal, a first electrode for receiving the first initialization voltage, and a second electrode connected to the sixth node, a fourteenth transistor including a control electrode for receiving the emission signal, a first electrode for receiving the first power voltage, and a second electrode connected to the seventh node, a fifteenth transistor including a control electrode for receiving the emission signal, a first electrode connected to the eighth node, and a second electrode connected to a ninth node, a sixteenth transistor including a control electrode for receiving the light-emitting element initialization signal, a first electrode for receiving the second initialization voltage, and a second electrode connected to the ninth node, and a second storage capacitor including a first electrode for receiving the first power voltage, and a second electrode connected to the sixth node.

The second initialization voltage may be substantially equal to the first initialization voltage.

The display panel may further include first to N-th pixel-rows and first to N-th sweep signal generators, N being a positive integer, wherein the first pixel-row and the first sweep signal generator are at a same row, and wherein the N-th pixel-row and the N-th sweep signal generator are at a same row.

According to embodiments, a sweep signal generator may include a tenth transistor configured to output a first power voltage to a sweep signal line, an eleventh transistor configured to apply a sweep data voltage to the tenth transistor in response to a write signal, and a fourteenth transistor configured to apply the first power voltage to the tenth transistor in response to an emission signal.

The sweep signal generator may further include a twelfth transistor connected to a control electrode of the tenth transistor, and to a second electrode of the tenth transistor, a thirteenth transistor configured to apply a first initialization voltage to the tenth transistor in response to an initialization signal, a fifteenth transistor configured to output the first power voltage to the sweep signal line in response to the emission signal, a sixteenth transistor configured to apply a second initialization voltage to the sweep signal line in response to a light-emitting element initialization signal, and a second storage capacitor including a first electrode for receiving the first power voltage, and a second electrode connected to the control electrode of the tenth transistor.

The light-emitting element initialization signal may be substantially equal to the initialization signal.

The second initialization voltage may be substantially equal to the first initialization voltage.

The sweep signal generator may include the tenth transistor including a control electrode connected to a sixth node, a first electrode connected to a seventh node, and a second electrode connected to an eighth node, the eleventh transistor including a control electrode for receiving the write signal, a first electrode for receiving the sweep data voltage, and a second electrode connected to the seventh node, a twelfth transistor including a control electrode for receiving the write signal, a first electrode connected to the eighth node, and a second electrode connected to the sixth node, a thirteenth transistor including a control electrode for receiving an initialization signal, a first electrode for receiving a first initialization voltage, and a second electrode connected to the sixth node, the fourteenth transistor including a control electrode for receiving the emission signal, a first electrode for receiving the first power voltage, and a second electrode connected to the seventh node, a fifteenth transistor including a control electrode for receiving the emission signal, a first electrode connected to the eighth node, and a second electrode connected to a ninth node, a sixteenth transistor including a control electrode for receiving a light-emitting element initialization signal, a first electrode for receiving a second initialization voltage, and a second electrode connected to the ninth node, and a second storage capacitor including a first electrode for receiving the first power voltage, and a second electrode connected to the sixth node.

According to embodiments, an electronic device may include a display panel including a pixel, and a sweep signal generator configured to generate a sweep signal, a data driver configured to apply a pixel data voltage, a sweep data voltage, and a pulse width modulation data voltage to the display panel, a gate driver configured to output a write signal, a pulse width modulation write signal, an initialization signal, and a light-emitting element initialization signal, and an emission driver configured to apply an emission signal to the display panel, wherein the pixel includes a light-emitting element, a pixel circuit block configured to apply a driving current to the light-emitting element in response to the pixel data voltage and the pulse width modulation write signal, and having a structure that is consistent with a structure of the sweep signal generator, and a pulse width modulation block configured to apply the pulse width modulation write signal to the pixel circuit block based on the pulse width modulation write signal, the sweep signal from the sweep signal generator, and the pulse width modulation data voltage.

As described above, the sweep signal generator may generate a sweep signal for applying a pulse width modulation method. A structure of the sweep signal generator may be consistent with a structure of some part of a pixel. Accordingly, the display device may omit a line for driving the sweep signal generator. Additionally, the dead space of the display device may be reduced effectively.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present disclosure.

FIG. 2 is a circuit diagram illustrating an example of a pixel included in a display device of FIG. 1.

FIG. 3 is a circuit diagram illustrating an example of a sweep signal generator included in a display device of FIG. 1.

FIG. 4 is a timing diagram illustrating signals applied to a pixel of FIG. 2 and a sweep signal generator of FIG. 3.

FIG. 5 is a circuit diagram illustrating an example of a pixel included in a display device of FIG. 1.

FIG. 6 is a circuit diagram illustrating an example of a sweep signal generator included in a display device of FIG. 1.

FIG. 7 is a timing diagram illustrating signals applied to a pixel of FIG. 5 and a sweep signal generator of FIG. 6.

FIG. 8 is a circuit diagram illustrating an example of a pixel included in a display device of FIG. 1.

FIG. 9 is a circuit diagram illustrating an example of sweep signal generator included in a display device of FIG. 1.

FIG. 10 is a block diagram illustrating an example of a pixel and a sweep signal generator of a display device of FIG. 1.

FIG. 11 is a circuit diagram illustrating an N-th pixel-row and an N-th sweep signal generator of FIG. 10.

FIG. 12 to FIG. 17 is a layout diagram illustrating a display device of FIG. 1.

FIG. 18 is a block diagram illustrating an electronic device according to one or more embodiments of the present disclosure.

FIG. 19 is a diagram illustrating an example in which the electronic device of FIG. 18 is implemented as a smart phone.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object.

In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

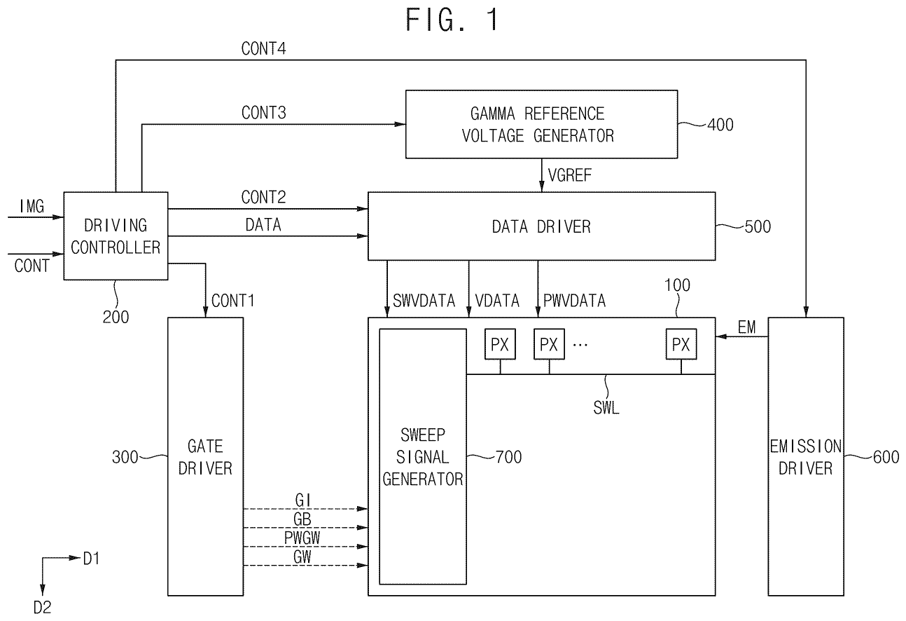

FIG. 1 is a block diagram illustrating a display device according to embodiments of the present disclosure.

Referring to FIG. 1, the display device may include a display panel 100 and a display panel driver. The display panel driver may include a driving controller 200, a gate driver 300, a gamma reference voltage generator 400, a data driver 500, an emission driver 600, a sweep signal generator 700.

The display panel 100 may include a display region displaying an image and a peripheral region located adjacent to the display region. In one or more embodiments, the gate driver 300 may be mounted in the peripheral region. In one or more embodiments, the gate driver 300 may be integrated into the peripheral region.

The display panel 100 may include a plurality of gate lines, a plurality of data lines, a plurality of emission lines EL, a plurality of sweep signal lines SWL, and a plurality of pixel PX electrically connected to the gate lines GL, the data lines DL, the emission lines EL, and the sweep signal lines SWL. The gate lines GL may extend in a first direction D1, and the data lines DL may extend in a second direction D2 crossing the first direction D1. The emission lines EL may extend in a first direction D1. The sweep signal lines SWL may extend in the first direction D1.

The driving controller 200 receives input image data IMG and an input control signal CONT from an external apparatus. For example, the input image data IMG may include red image data, green image data, and blue image data. The input image data IMG may include white image data. The input image data IMG may include magenta image data, cyan image data, and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4, and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal. The driving controller 200 generates the second control signal CONT2 for

controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals GI, GB, GW, and PWGW driving the gate lines GL in response to the first control signal CONT1 received from the driving controller 200. The gate driver 300 may output the gate signals GI, GB, GW and PWGW to the gate lines GL. For example, the gate signals GI, GB, GW and PWGW may include an initialization signal GI, a light-emitting element initialization signal GB, a write signal GW and a pulse width modulation write signal PWGW.

In one or more embodiments, the gate driver 300 may be located in the peripheral region. In one or more embodiments, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

For example, the gamma reference voltage generator 400 may be located in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into analog type of data voltages using the gamma reference voltages VGREF. The analog type of data voltages includes a pixel data voltage VDATA, a sweep data voltage SWVDATA, and a pulse width modulation data voltage PWVDATA. The data driver 500 may output the pixel data voltage VDATA, the sweep data voltage SWVDATA, and the pulse width modulation data voltage PWVDATA to the display panel 100.

The data driver 500 applies the sweep data voltage SWVDATA to the sweep signal generator 700.

In one or more embodiments, the data driver 500 may be located in the peripheral region. In one or more embodiments, the data driver 500 may be integrated in the peripheral region.

The emission driver 600 generates an emission signal driving the emission lines EL in response to the fourth control signal CONT4 received from the driving controller 200. The emission driver 600 may output the emission signal to the emission lines EL.

In one or more embodiments, the emission driver 600 may be located in the peripheral region. In one or more embodiments, the emission driver 600 may be integrated in the peripheral region.

The sweep signal generator 700 may be located in the peripheral region. In one or more embodiments, the sweep signal generator 700 may be integrated in the peripheral region.

The sweep signal generator 700 generates the sweep signal SW for driving the sweep signal line SWL in response to the gate signals GI, GB, GW and PWGW received from the gate driver 300 and the sweep data voltage SWVDATA received from the data driver 500. The sweep signal generator 700 may output the sweep signals SW to the sweep signal lines SWL.

Although the gate driver 300 is located on a first side of the display panel 100, and the emission driver 600 is located on a second side of the display panel 100 in FIG. 1 for convenience of explanation, the present disclosure is not limited thereto. The gate driver 300 and the emission driver 600 may be located on the first side of the display panel 100. For example, the gate driver 300 and the emission driver 600 may be located on the peripheral region of the display panel 100 on the same side of the display region of the display panel 100. For example, the gate driver 300 and the emission driver 600 may be formed integrally with each other.

The display device according to one or more embodiments may be a device for displaying a video or still image, and may be used as a display screen for various products, such as television, laptops, monitors, billboards, Internet of Things (IoTs), as well as portable electronic devices, such as mobile phone, smart phone, tablet personal computer (PC), mobile communication terminal, electronic notebook, electronic book, portable multimedia player PMP, navigation system, and ultra mobile PC UMPC. In addition, the display device according to one or more embodiments may be used in wearable devices, such as smart watches, watch phones, glasses-type displays, head-mounted displays HMDs, virtual reality (VR) devices, or augmented reality (AR) devices. In addition, the display device according to one or more embodiments may be used as a dashboard of a vehicle, a center information display (CID) disposed in a center fascia or a dashboard of the vehicle, a room mirror display replacing a side mirror of the vehicle, an entertainment element for a rear seat of the vehicle, and a display disposed on a rear surface of the front seat.

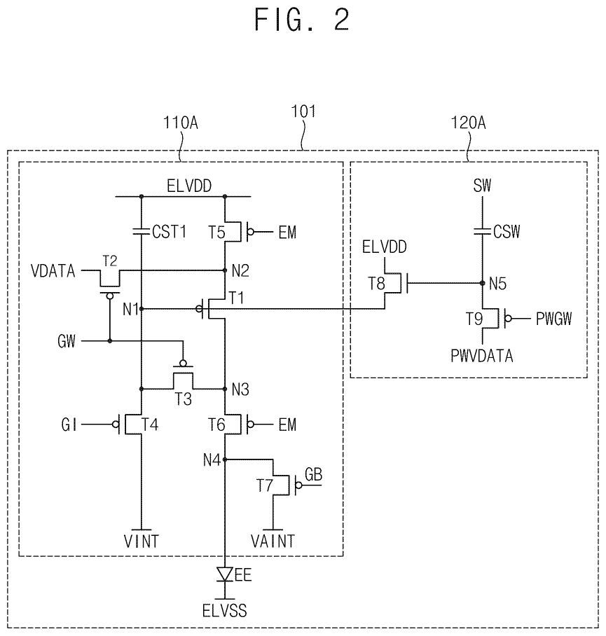

FIG. 2 is a circuit diagram illustrating an example of a pixel 101 included in a display device of FIG. 1.

Referring to FIG. 1 and FIG. 2, a pixel 101 may include a pixel circuit block 110A, a pulse width modulation block 120A, and a light-emitting element EE.

In one or more embodiments, the pixel circuit block 110A may include a first transistor T1, a second transistor T2, a third transistor T3, a fourth transistor T4, a fifth transistor T5, a sixth transistor T6, a seventh transistor T7, and a first storage capacitor CST1.

The first transistor T1 may generate a driving current based on a voltage of a first node N1. For example, the first transistor T1 may be called a driving transistor for generating the driving current. In one or more embodiments, the first transistor T1 may include a control electrode connected to the first node N1, a first electrode connected to a second node N2, and a second electrode connected to a third node N3.

The second transistor T2 may apply the pixel data voltage VDATA to the second node N2 in response to the write signal GW. For example, the second transistor T2 may be called a data writing transistor. In one or more embodiments, the second transistor T2 may include a control electrode for receiving the write signal GW, a first electrode for receiving the pixel data voltage VDATA, and a second electrode connected to the second node N2. For example, an operation in which the second transistor T2 is turned on and the pixel data voltage VDATA is applied to the first node N1 may be called a data writing operation.

The third transistor T3 may apply a voltage (e.g., a data compensation voltage), which is sum of the pixel data voltage VDATA and a threshold voltage of the first transistor T1, to the first node N1. For example, the third transistor T3 may be called a compensation transistor. In one or more embodiments, the third transistor T3 may include a control electrode for receiving the write signal GW, a first electrode connected to the third node N3, and a second electrode connected to the first node N1.

For convenience of explanation, the third transistor T3 is illustrated in the form of a single transistor, however the third transistor T3 may also be configured in the form of a dual transistor including two transistors connected in series.

The fourth transistor T4 may apply a first initialization voltage VINT to the first node N1 in response to the initialization signal GI. For example, the fourth transistor T4 may be called an initialization transistor. In one or more embodiments, the fourth transistor T4 may include a control electrode for receiving the initialization signal GI, a first electrode for receiving the first initialization voltage VINT, and a second electrode connected to the first node N1.

For convenience of explanation, the fourth transistor T4 is illustrated in the form of a single transistor, but the fourth transistor T4 may also be configured in the form of a dual transistor including two transistors connected in series.

The fifth transistor T5 may apply a first power voltage ELVDD (e.g., a high power voltage) to the second node N2 in response to the emission signal EM. For example, the fifth transistor T5 may be called an emission control transistor. In one or more embodiments, the fifth transistor T5 may include a control electrode for receiving the emission signal EM, a first electrode for receiving the first power voltage ELVDD, and a second electrode connected to the second node N2.

The sixth transistor T6 may include a control electrode for receiving the emission signal EM, a first electrode connected to the third node N3, and a second electrode connected to the fourth node N4.

The seventh transistor T7 may include a control electrode for receiving the write signal GW, a first electrode for receiving a second initialization voltage VAINT, and a second electrode connected to the fourth node N4. In one or more embodiments, the first initialization voltage VINT may be same with the second initialization voltage VAINT. For example, a voltage level of the second initialization voltage VAINT may be called a low sweep level.

For example, the first to seventh transistors T1 to T7 may be P-type transistors. The control electrodes of the first to seventh transistors T1 to T7 may be gate electrodes, the first electrodes of the first to seventh transistors T1 to T7 may be source electrodes, and a second electrodes of the first to seventh transistors T1 to T7 may be drain electrodes. The source electrodes and the drain electrodes of the first to seventh transistors T1 to T7 may be called oppositely to each other.

The pixel data voltage VDATA may have same voltage levels for all pixels. The pixel data voltage VDATA may have a first voltage level for a red pixel, a second voltage level that is different from the first voltage level for a green pixel, and a third voltage level that is different from the first and second voltage levels for a blude pixel.

The first storage capacitor CST1 may include a first electrode for receiving the first power voltage ELVDD, and a second electrode connected to the first node N1.

The pulse width modulation block 120A may include an eighth transistor T8, a ninth transistor T9, and a sweep capacitor CSW.

The eighth transistor T8 may include a control electrode connected to a fifth node N5, a first electrode for receiving the first power voltage ELVDD, and a second electrode connected to the first node N1. In one or more embodiments, the eighth transistor T8 may be an N-type transistor.

The ninth transistor T9 may include a control electrode for receiving the pulse width modulation write signal PWGW, a first electrode for receiving the pulse width modulation data voltage PWVDATA, and a second electrode connected to the fifth node N5

The sweep capacitor CSW may include a first electrode connected to the sweep signal line SWL, and a second electrode connected to the fifth node N5.

The light-emitting element EE may include an anode connected to the fourth node N4, and a cathode for receiving a second power voltage ELVSS. The second power voltage ELVSS may be lower than the first power voltage ELVDD.

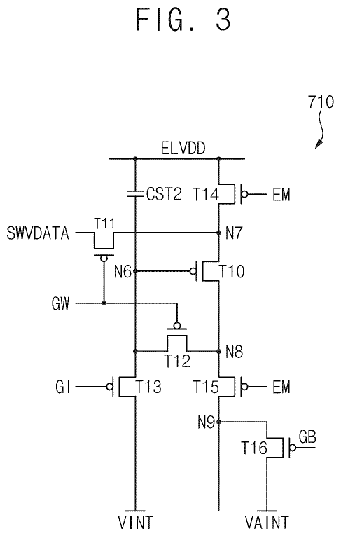

FIG. 3 is a circuit diagram illustrating an example of a sweep signal generator 710 included in a display device of FIG. 1.

A structure of the sweep signal generator 710 may be consistent with (e.g., similar or substantially identical to) a structure of the pixel circuit block 110A.

For example, the sweep signal generator 710 may include a tenth transistor T10, an eleventh transistor T11, a twelfth transistor T12, a thirteenth transistor T13, a fourteenth transistor T14, a fifteenth transistor T15, a sixteenth transistor T16 and a second storage capacitor CST2.

The tenth transistor T10 may include a control electrode connected to a sixth node N6, a second control electrode connected to the eighth node N8. The tenth transistor T10 may generate a sweep signal SW based on a voltage of the sixth node N6.

The eleventh transistor T11 may include a control electrode for receiving the write signal GW, a first electrode for receiving the sweep data voltage SWVDATA, and a second electrode connected to the seventh node N7.

The twelfth transistor T12 may include a control electrode for receiving the write signal GW, a first electrode connected to the eighth node N8, and a second electrode connected to the sixth node N6.

For convenience of explanation, the twelfth transistor T12 is illustrated in the form of a single transistor, but the twelfth transistor T12 may also be configured in the form of a dual transistor including two transistors connected in series.

The thirteenth transistor T13 may include a control electrode for receiving the initialization signal GI, a first electrode for receiving the first initialization voltage VINT, and a second electrode connected to the sixth node N6.

For convenience of explanation, the thirteenth transistor T13 is illustrated in the form of a single transistor, but the thirteenth transistor T13 may also be configured in the form of a dual transistor including two transistors connected in series.

The fourteenth transistor T14 may include a control electrode for receiving the emission signal EM, a first electrode for receiving the first power voltage ELVDD, and a second electrode connected to the seventh node N7.

The fifteenth transistor T15 may include a control electrode for receiving the emission signal EM, a first electrode connected to the eighth node N8, and a second electrode connected to a ninth node N9. In one or more embodiments, the ninth node N9 and the fifth node N5 may be a same node.

The sixteenth transistor T16 may include a control electrode for receiving the write signal GW, a first electrode for receiving the second initialization voltage VAINT, and a second electrode connected to the ninth node N9. In one or more embodiments, the first initialization voltage VINT and the second initialization voltage VAINT may be same or different.

For example, the tenth to sixteenth transistors T10 to T16 may be P-type transistors. The control electrodes of the tenth to sixteenth transistors T10 to T16 may be gate electrodes, the first electrodes of the tenth to sixteenth transistors T10 to T16 may be source electrodes, and a second electrodes of the tenth to sixteenth transistors T10 to T16 may be drain electrodes. The source electrodes and the drain electrodes of the tenth to sixteenth transistors T10 to T16 may be called oppositely to each other.

Referring to FIG. 2 and FIG. 3, the structure of the pixel circuit block 110A may be consistent with the structure of the sweep signal generator 710. Accordingly, the display device may omit a line for driving the sweep signal generator 710. Additionally, the dead space of the display device may be reduced effectively.

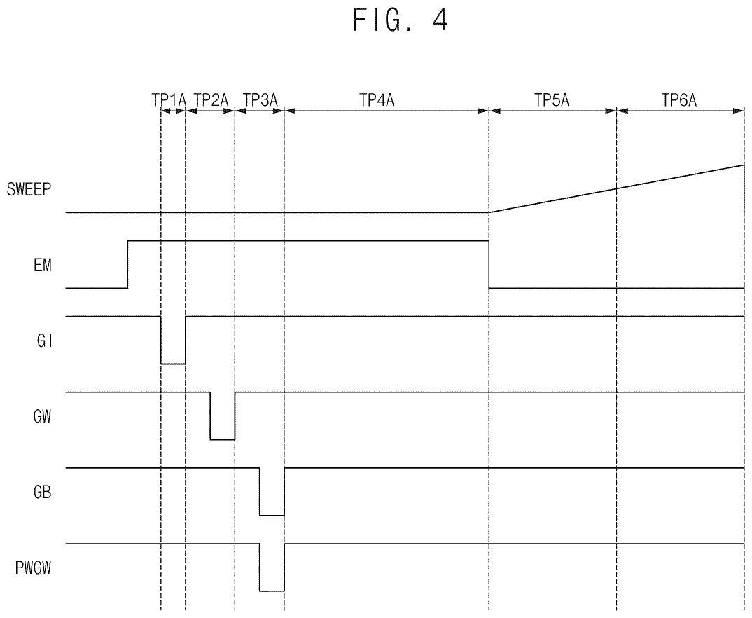

FIG. 4 is a timing diagram illustrating signals applied to a pixel 101 of FIG. 2 and a sweep signal generator 710 of FIG. 3.

Referring to FIG. 2 to FIG. 4, a frame period in which the pixel 101 and the sweep signal generator 710 is driven may include a first period TP1A, a second period TP2A, a third period TP3A, a fourth period TP4A, a fifth period TP5A and a sixth period TP6A. For example, an activation level of a P-type transistor may be a low level, and an inactivation level of the P-type transistor may be a high level. For example, an activation level of an N-type transistor may be a high level, and an inactivation level of the N-type transistor may be a low level. For example, the high level may be higher than the low level. For example, the high level may be the first power voltage ELVDD. In one or more embodiments, the high level may be called a sweep high level.

In the first period TP1A, the emission signal EM may have an inactivation level, the initialization signal GI may have an activation level, the write signal GW may have an inactivation level, the light-emitting element initialization signal GB may have an inactivation level, and the pulse width modulation write signal PWGW may have an inactivation level.

In the first period TP1A, the initialization signal GI may have an activation level, and the fourth transistor T4 may be turned on, so that the initialization voltage VINT may be applied to the first node N1. The first period TP1A may be called an initialization period.

In the first period TP1A, the initialization signal GI may have an activation level, and the thirteenth transistor T13 may be turned on, so that the initialization voltage VINT may be applied to the sixth node N6. Accordingly, the sixth node N6 may be initialized as the initialization voltage VINT.

In the second period TP2A, the emission signal EM may have an inactivation level, the initialization signal GI may have an inactivation level, the write signal GW may have an activation level, the light-emitting element initialization signal GB may have an inactivation level, and the pulse width modulation write signal PWGW may have an inactivation level.

In the second period TP2A, the write signal GW may have an activation level, so that the second transistor T2 and the third transistor T3 may be turned on. Additionally, the first transistor T1 may be turned on based on the initialization voltage VINT. For example, the second period TP2A may be called a writing period.

In the second period, through a path of the first to third transistors T1, T2 and T3, which are turned on, the voltage (e.g., the data compensation voltage), which is a sum of the pixel data voltage VDATA and a threshold voltage of the first transistor T1, may be applied to the first node N1.

In the second period TP2A, the write signal GW may have an activation level, and the eleventh transistor T11 and the twelfth transistor T12 may be turned on. Accordingly, the sweep data voltage SWVDATA may be applied to the sixth node N6. A sweep current may be generated based on the sweep data voltage SWVDATA. The sweep signal SW may be generated based on the sweep current. For example, when the sweep data voltage SWVDATA is higher than a reference sweep data voltage, the sweep current may be increased. Accordingly, the sweep signal SW may be increased rapidly. For example, when the sweep data voltage SWVDATA is lower than the reference sweep data voltage, the sweep current may be decreased. Accordingly, the sweep signal SW may be increased slowly. A slope of the sweep signal SW may be controlled based on the sweep data voltage SWVDATA.

In the third period TP3A, the emission signal EM may have an inactivation level, the initialization signal GI may have an inactivation level, the write signal GW may have an inactivation level, the light-emitting element initialization signal GB may have an activation level, and the pulse width modulation write signal PWGW may have an activation level.

In the third period TP3A, the light-emitting element initialization signal GB may have an activation level, so that the seventh transistor T7 may be turned on. Accordingly, the second initialization voltage VAINT may be applied to the fourth node N4. The third period TP3A may be called a light-emitting element initialization period. The light-emitting element initialization signal GB may have an activation level, so that the sixteenth transistor T16 may be turned on. Accordingly, the second initialization voltage VAINT may be applied to the ninth node N9.

In the third period TP3A, the second initialization voltage VAINT may be applied to the sweep signal line SWL. The sweep signal SW may have the sweep low level.

The pulse width modulation write signal PWGW may have an activation level, so that the ninth transistor T9 may be turned on. Accordingly, the pulse width modulation data voltage PWVDATA may be applied to the fifth node N5. Based on a voltage level of the pulse width modulation data voltage PWVDATA, a turned off period of the eighth transistor T8 may be determined.

In the fourth period TP4A, the emission signal EM may have an inactivation level, the initialization signal GI may have an inactivation level, the write signal GW may have an inactivation level, the light-emitting element initialization signal GB may have an inactivation level, and the pulse width modulation write signal PWGW may have an inactivation level. The fourth period TP4A may be called an emission signal waiting period.

In the fifth period TP5A, the sweep signal SW may be gradually increased from the sweep low level, the emission signal EM may have an activation level, the initialization signal GI may have an inactivation level, the write signal GW may have an inactivation level, the light-emitting element initialization signal GB may have an inactivation level, and the pulse width modulation write signal PWGW may have an inactivation level.

In the fifth period TP5A, the emission signal EM may have an activation level, so that the fifth transistor T5 and the sixth transistor T6 may be turned on. Additionally, the first transistor T1 may be turned on. In the fifth period TP5A, a voltage of the fifth node N5 may be lower than a threshold voltage of the eighth transistor T8, so that the eighth transistor T8 may be turned off. For example, the fifth period TP5A may be called an emission-on period.

In the fifth period TP5A, the driving current may drive the light-emitting element EE through a path of the first transistor T1 and the sixth transistor T6. An intensity of the driving current may be determined as a level of the pixel data voltage VDATA.

In the fifth period TP5A, the fourteenth transistor T14 and the fifteenth transistor T15 may be turned on in response to the emission signal EM. Accordingly, the sweep signal generated based on the sweep data voltage SWVDATA may be applied to the ninth node N9. Accordingly, a voltage of the ninth node N9 may be increased from the second initialization voltage VAINT. For example, the voltage of the ninth node N9 may be increased from the sweep low level. Accordingly, the sweep signal SW may be gradually increased.

In the fifth period TP5A, a sweep signal generator 710 having the same structure as the pixel circuit block 110A may output the sweep signal SW to the sweep signal line SWL in response to the emission signal EM. The sweep signal SW may be gradually increased or decreased based on a capacitance of the sweep signal line SWL.

In the sixth period TP6A, the sweep signal SW may be gradually increased to the sweep high level, the emission signal EM may have an activation level, the initialization signal GI may have an inactivation level, the write signal GW may have an inactivation level, the light-emitting element initialization signal GB may have an inactivation level, and the pulse width modulation write signal PWGW may have an inactivation level.

In the sixth period TP6A, the sweep signal SW may be gradually increased, so that a voltage of the fifth node N5 may be gradually increased. Eighth transistor T8 may be an N-type transistor. When the voltage of the fifth node N5 is higher than the threshold voltage of the eighth transistor T8, the eighth transistor T8 may be turned on. When the eighth transistor T8 is turned on, the first power voltage ELVDD may be applied to the first node N1 and the first transistor T1 may be turned off.

A time in which the eighth transistor T8 maintains a turned off state may be determined based on the pulse width modulation data voltage PWVDATA. For example, when the pulse width modulation data voltage PWVDATA has a first voltage, a time in which the eighth transistor T8 maintains the turn-off state may be a first time. For example, when the pulse width modulation data voltage PWVDATA has a second voltage lower than the first voltage, a time in which the eighth transistor T8 maintains the turn-off state may be longer than the first time.

Accordingly, an emission time of the light-emitting element EE may be controlled based on the pulse width modulation data voltage PWVDATA. Accordingly, a grayscale of the display panel 100 may be controlled. The control method may be a pulse width modulation method.

The structure of the pixel circuit block 100A may be consistent with the structure of the sweep signal generator 710, so that the pixel circuit block 110A may emit light in an emission period in response to the emission signal EM, and the sweep signal generator 710 may output the first power voltage ELVDD as the sweep signal SW in the emission period. Accordingly, the emission period may be synchronized with the sweep signal outputting period.

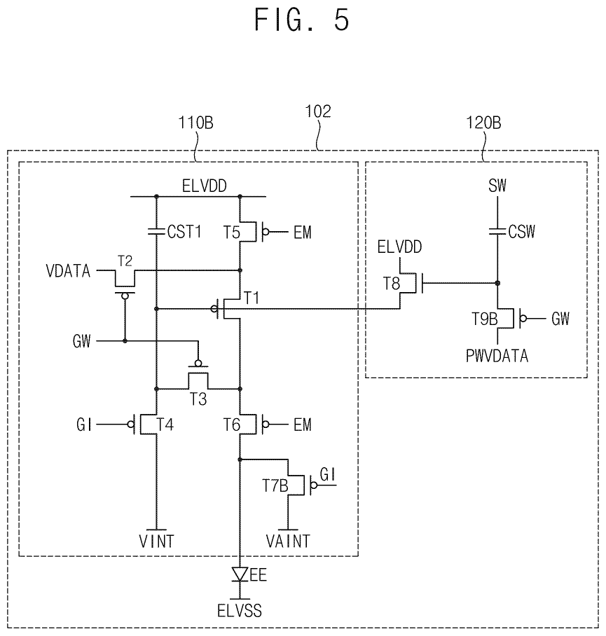

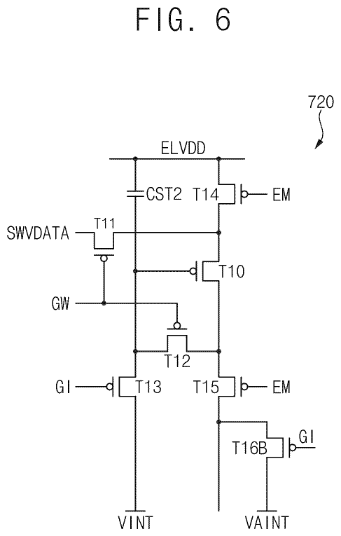

FIG. 5 is a circuit diagram illustrating an example of a pixel 102 included in a display device of FIG. 1. FIG. 6 is a circuit diagram illustrating an example of a sweep signal generator 720 included in a display device of FIG. 1.

A pixel 102 is substantially same as the pixel 101 of FIG. 2 except that the initialization signal GI is applied to a seventh transistor T7B of the pixel circuit block 110B, and the write signal GW is applied to a ninth transistor T9B of the pulse width modulation block 120B. Accordingly, the same reference numerals will be used and any repetitive explanation concerning the above elements will be omitted.

A sweep signal generator 720 is substantially same as the sweep signal generator 710 of FIG. 3 except that the initialization signal GI is applied to a sixteenth transistor T16B. Accordingly, the same reference numerals will be used and any repetitive explanation concerning the above elements will be omitted.

Referring to FIG. 5 and FIG. 6, a structure of the pixel circuit block 110B and a structure of the sweep signal generator 720. Accordingly, the display device may omit a line for driving the sweep signal generator 720. Additionally, the dead space of the display device may be reduced effectively.

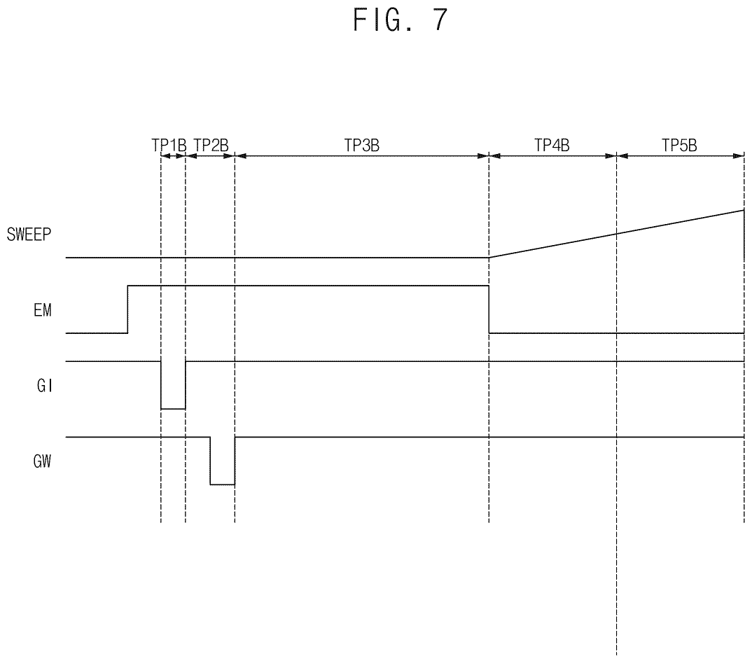

FIG. 7 is a timing diagram illustrating signals applied to a pixel 102 of FIG. 5 and a sweep signal generator 720 of FIG. 6.

Referring to FIG. 5 to FIG. 7, a frame period in which the pixel 102 and the sweep signal generator 720 is driven may include a first period TP1B, a second period TP2B, a third period TP3B and a fourth period TP4B. For example, an activation level of a P-type transistor may be a low level, and an inactivation level of the P-type transistor may be a high level. For example, an activation level of an N-type transistor may be a high level, and an inactivation level of the N-type transistor may be a low level. For example, the high level may be higher than the low level.

In the first period TP1B, the emission signal EM may have an inactivation level, the initialization signal GI may have an activation level, and the write signal GW may have an inactivation level.

In the first period TP1B, the initialization signal GI may have the activation level and the fourth transistor T4 may be turned on, so that the initialization voltage VINT may be applied to the first node N1. Additionally, the initialization signal GI may have an activation level, so that the seventh transistor T7B may be turned on. The initialization signal GI may have an activation level, so that the sixteenth transistor T16B may be turned on. Accordingly, the second initialization voltage VAINT may be applied to the ninth node N9.

In the first period TP1B, the second initialization voltage VAINT may be applied to the sweep signal line SWL. The sweep signal SW may have the sweep low level.

In the second period TP2B, the emission signal EM may have an inactivation level, the initialization signal GI may have an inactivation level, and the write signal GW may have an activation level.

In the second period TP2B, the write signal GW may have an activation level, so that the second transistor T2 and the third transistor T3 may be turned on. Additionally, the first transistor T1 may be turned on based on the initialization voltage VINT.

In the second period TP2B, through a path of the first to third transistors T1, T2 and T3, which are turned on, the voltage (e.g., the data compensation voltage), which is sum of the pixel data voltage VDATA and a threshold voltage of the first transistor T1, may be applied to the first node N1.

In the second period TP2B, the write signal GW may have an activation level, so that the ninth transistor T9 may be turned on. Accordingly, the pulse width modulation data voltage PWVDATA may be applied to the fifth node N5.

In the second period TP2B, the write signal GW may have an activation level, so that the eleventh transistor T11 and the twelfth transistor T12 may be turned on. Accordingly, the sweep data voltage SWVDATA may be applied to the sixth node N6. A sweep current may be generated based on the sweep data voltage SWVDATA. The sweep signal SW may be generated based on the sweep current.

In the third period TP3B, the emission signal EM may have an inactivation level, the initialization signal GI may have an inactivation level, and the write signal GW may have an inactivation level.

In the fourth period TP4B, the emission signal EM may have an activation level, the initialization signal GI may have an inactivation level, and the write signal GW may have an inactivation level.

In the fourth period TP4B, the emission signal EM may have an activation level, the fifth transistor T5 and the sixth transistor T6 may be turned on. Additionally, the first transistor T1 may be turned on. In the fourth period TP4B, a voltage of the fifth node N5 may be lower than a threshold voltage of the eighth transistor T8, so that the eighth transistor T8 may be turned off. For example, the fourth period TP4B may be the emission-on period.

In the fourth period TP4B, the driving current may drive the light-emitting element EE through a path of the fifth transistor T5, the first transistor T1, and the sixth transistor T6. An intensity of the driving current may be determined as a level of the pixel data voltage VDATA.

In the fourth period TP4B, a sweep signal generator 720 having the same structure as the pixel circuit block 110B may output first power voltage ELVDD to the sweep signal line SWL in response to the emission signal EM. The sweep signal SW may be gradually increased or decreased based on a capacitance of the sweep signal line SWL.

In the fifth period TP5B, the sweep signal SW may be gradually increased to the sweep high level, the emission signal EM may have an activation level, the initialization signal GI may have an inactivation level, and the write signal GW may have an inactivation level.

In the fifth period TP5B, the sweep signal SW may be gradually increased to the sweep high level, the emission signal EM may have an activation level, the initialization signal GI may have an inactivation level, and the write signal GW may have an inactivation level.

In the fifth period TP5B, the fourteenth transistor T14 and the fifteenth transistor T15 may be turned on in response to the emission signal EM. Accordingly, the sweep current generated based on the sweep data voltage SWVDATA may be applied to the ninth node N9. Accordingly, a voltage of the ninth node N9 may be increased from the second initialization voltage VAINT. For example, the voltage of the ninth node N9 may be increased from the sweep low level. Accordingly, the sweep signal SW may be gradually increased.

In the fifth period TP5B, the sweep signal SW may be gradually increased, so that a voltage of the fifth node N5 may be gradually increased. Eighth transistor T8 may be an N-type transistor. When the voltage of the fifth node N5 is higher than the threshold voltage of the eighth transistor T8, the eighth transistor T8 may be turned on. When the eighth transistor T8 is turned on, the first power voltage ELVDD may be applied to the first node N1 and the first transistor T1 may be turned off.

The light-emitting element initialization signal GB may be applied instead of the initialization signal GI, and the write signal GW may be applied instead of the pulse width modulation write signal PWGW, so that the number of signals of the display device may be reduced. Accordingly, an integration of the display device may be improved.

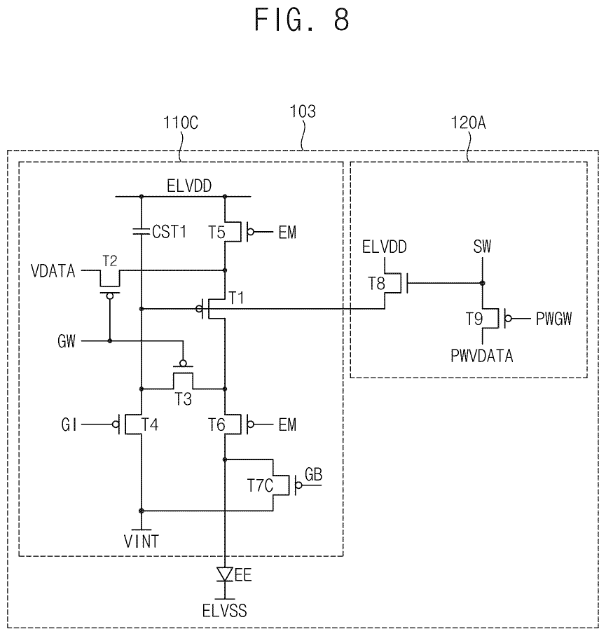

FIG. 8 is a circuit diagram illustrating an example of a pixel 103 included in a display device of FIG. 1.

A pixel 103 of FIG. 8 may include a pixel circuit block 110C and a pulse width modulation block 120A.

The pixel 103 is substantially same as the pixel 101 of FIG. 2 except that the first initialization voltage VINT is applied to a first electrode of a seventh transistor T7C of the pixel circuit block 110C instead of the second initialization voltage VAINT. Accordingly, the same reference numerals will be used and any repetitive explanation concerning the above elements will be omitted.

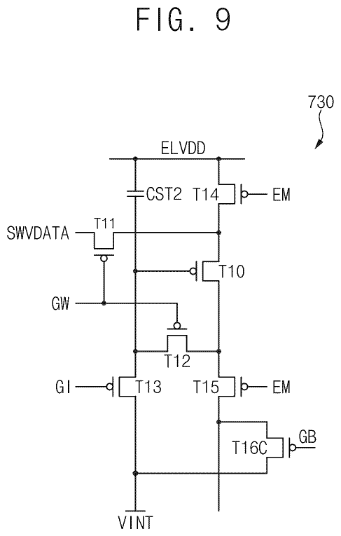

FIG. 9 is a circuit diagram illustrating an example of sweep signal generator 730 included in a display device of FIG. 1.

A sweep signal generator 730 is substantially same as the sweep signal generator 710 of FIG. 3 except that the first initialization voltage VINT is applied to a first electrode of a sixteenth transistor T16C instead of the second initialization voltage VAINT. Accordingly, the same reference numerals will be used and any repetitive explanation concerning the above elements will be omitted.

The first initialization voltage VINT may be applied instead of the second initialization voltage VAINT, so that the number of lines included in the display device may be reduced. Accordingly, an integration of the display device may be improved.

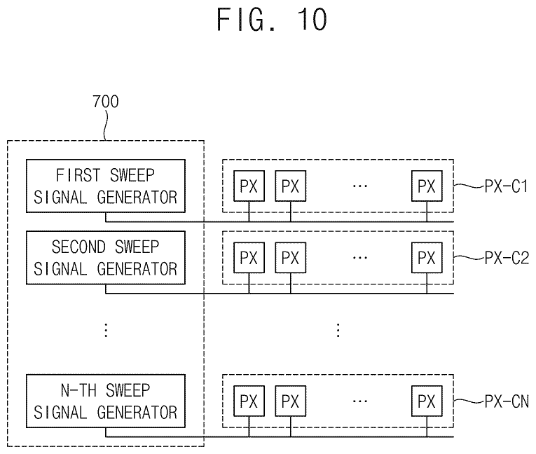

FIG. 10 is a block diagram illustrating an example of a pixel and a sweep signal generator of a display device of FIG. 1.

Referring to FIG. 10, the display device may include first to N-th pixel-rows PX-C1 to PX-CN and first to N-th sweep signal generator, where N is a positive integer. The first pixel-row PX-C1 and the first sweep signal generator may be located on a same row. The second pixel-row PX-C2 and the second sweep signal generator may be located on a same row. The N-th pixel-row PX-CN and the N-th sweep signal generator may be located on a same row.

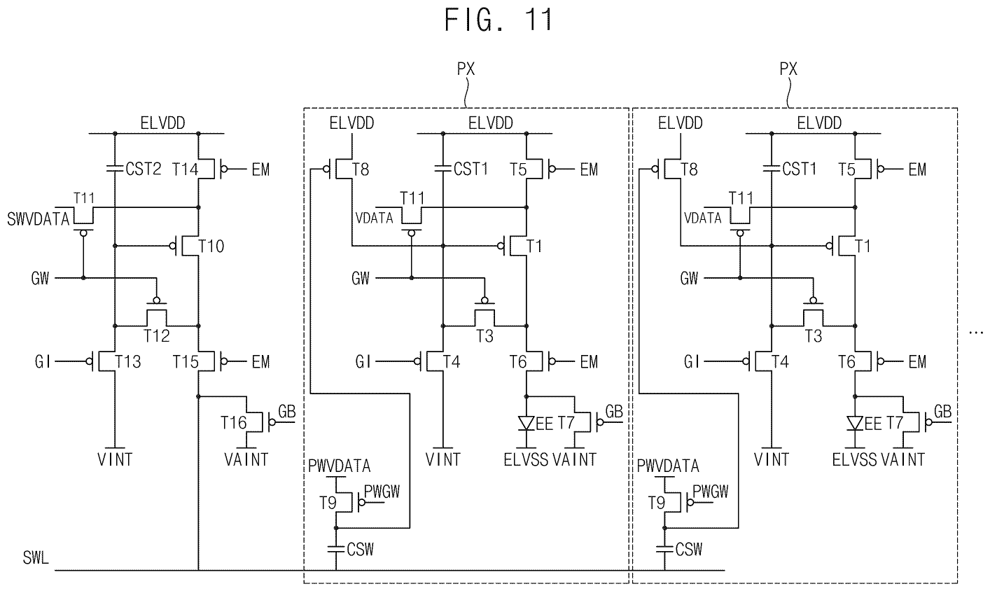

FIG. 11 is a circuit diagram illustrating an N-th pixel-row and an N-th sweep signal generator of FIG. 10.

Referring to FIG. 11, the N-th pixel-row PX-CN and the N-th sweep signal generator may be located on a same row. A structure of the N-th sweep signal generator may be consistent with the structure of the pixel circuit block 110A included in the N-th pixel-row PX-CN. Accordingly, the display device may omit a line for driving the sweep signal generator. Additionally, a dead space of the display device may be reduced effectively.

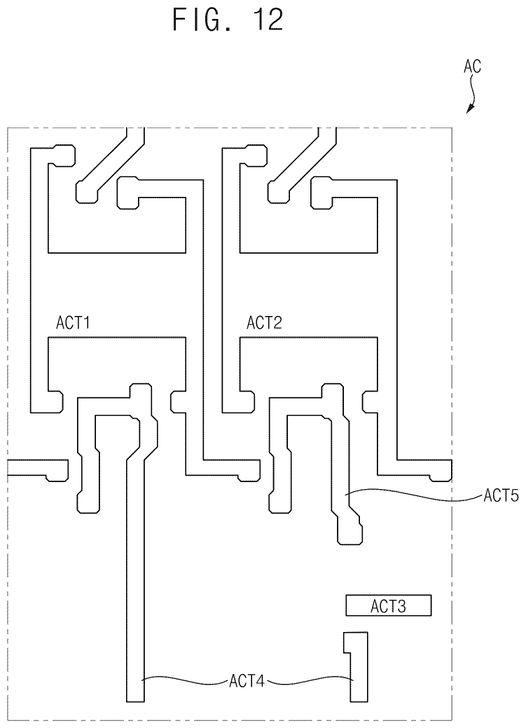

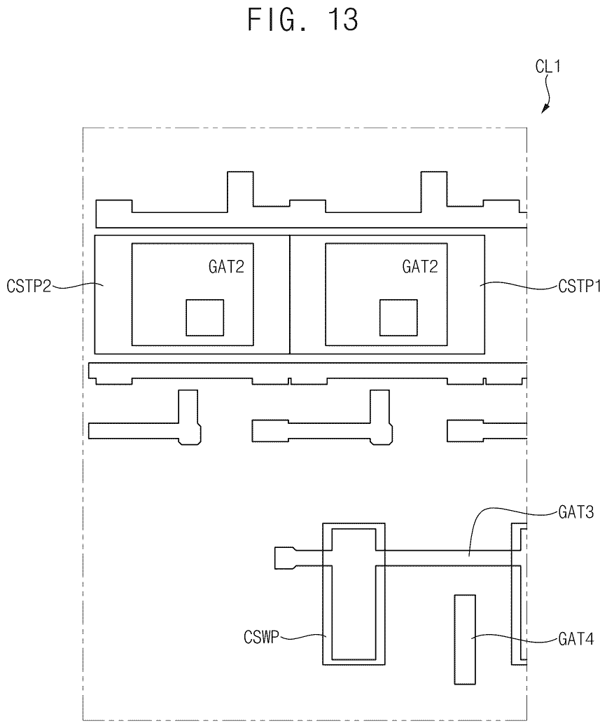

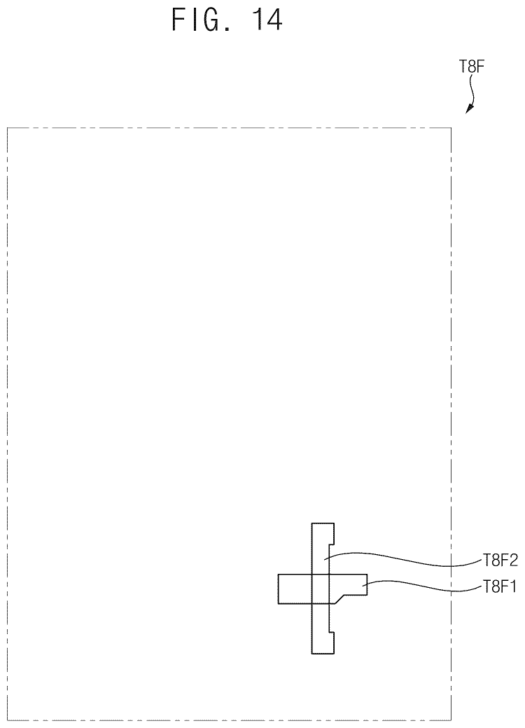

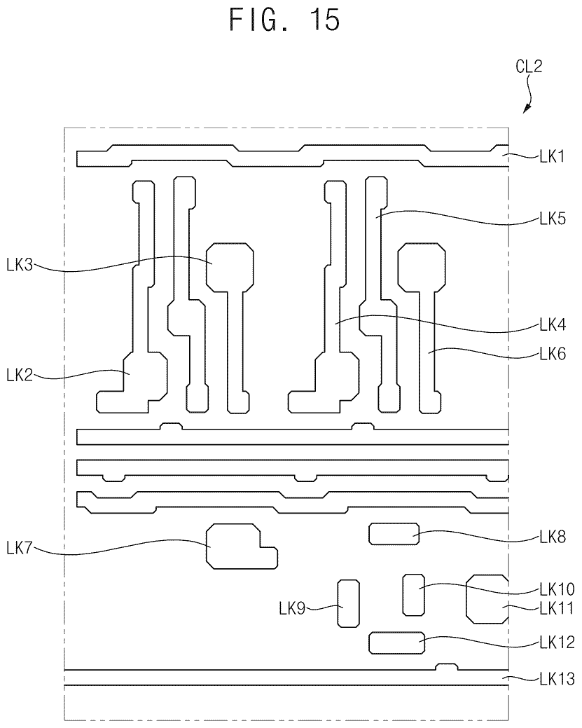

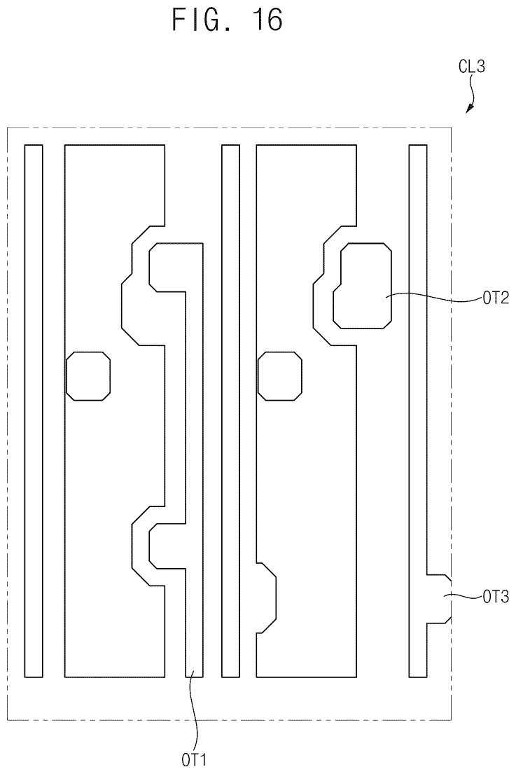

FIG. 12 to FIG. 17 is a layout diagram illustrating a display device of FIG. 1.

Referring to FIG. 12 to FIG. 17, the display device may include pixels located adjacently each other. Additionally, the display device may include a sweep signal generator located adjacent to the pixels. For example, a first part SEC1 of FIG. 12 to FIG. 17 may be some part of the sweep signal generator 700, and a second part SEC2 may be some part of the pixel PX.

The first part SEC1 and the second part SEC2 are layout diagrams for explaining a structure in which the tenth transistor T10 of the sweep signal generator 700, and the first transistor T1, the eighth transistor T8 and the ninth transistor T9 of the pixel PX are connected through the sweep signal line SWL. The second to seventh transistors T2, T3, T4, T5, T6 and T7 and the eleventh to sixteenth transistors T11, T12, T13, T14, 15 and T16 are omitted, and the drawing is centered on the first transistor T1, the eighth transistor T8, the ninth transistor T9, the tenth transistor T10, the sweep signal line SWL, and the first power voltage line.

Referring to FIG. 11 and FIG. 12, the display device may include an active layer AC.

The active layer AC may include first to fifth active patterns ACT1, ACT2, ACT3, ACT4, and ACT5 spaced apart from each other. The first active pattern ACT1 form the tenth transistor T10. The second active pattern ACT2 form the first transistor T1. The third active pattern ACT3 form the ninth transistor T9. The fourth active pattern ACT4 form the first power voltage line. The first power voltage line may be line to which the first power voltage ELVDD is applied. The fifth active pattern ACT5 may electrically connect the eighth transistor T8 and the first transistor T1.

Referring to FIG. 11 to FIG. 13, the display device may further include a first conductive layer CL1.

A first conductive layer CL1 may be located on the active layer AC. For example, a first insulating layer may be located on the active layer AC, and the first conductive layer CL1 may be located on the first insulating layer.

The first conductive layer CL1 may include a first gate pattern GAT1, a second gate pattern GAT1, a third gate pattern GAT3, and a fourth gate pattern GAT4. The first gate pattern GAT1 form the tenth transistor T10. The second gate pattern GAT2 form the first transistor T1. The third gate pattern GAT3 form the sweep signal line SWL and the sweep capacitor CSW. The fourth gate pattern GAT4 form the ninth transistor T9.

The display device may further include a second storage pattern for forming the second storage capacitor CST2 on the first gate pattern GAT1. The display device may further include a first storage pattern for forming the first storage capacitor CST1 on the second gate pattern GAT2. The display device may further include a sweep capacitor pattern for forming the sweep capacitor CSW on the third gate pattern GAT3.

Referring to FIG. 11 to FIG. 14, the display device may further include an eighth transistor formation layer T8F.

An eighth transistor formation layer T8F may be located on the first conductive layer CL1. For example, a second insulating layer may be located on the first conductive layer CL1, and the eighth transistor formation layer T8F may be located on the second insulating layer.

The eighth transistor formation layer T8F may include a first formation layer T8F1 and a second formation layer T8F2. The first formation layer T8F1 form the first electrode of the eighth transistor T8 and the second electrode of the eighth transistor T8. The second formation layer T8F2 form the control electrode of the eighth transistor T8. The second formation layer T8F2 may be located on the first formation layer T8F1.

Referring to FIG. 11 to FIG. 15, the display device may further include a second conductive layer CL2.

The second conductive layer CL2 may be located on the eighth transistor formation layer T8F. For example, a third insulating layer may be located on the eighth transistor formation layer T8F, and the second conductive layer CL2 may be located on the third insulating layer.

The second conductive layer CL2 may include first to thirteenth connection patterns LK1, LK2, LK3, LK4, LK5, LK6, LK7, LK8, LK9, LK10, LK11, LK12, and LK13. The first connection pattern LK1 form the data line. The second connection pattern LK2 may apply the first power voltage ELVDD to the tenth transistor T10. The third connection pattern LK3 may apply the sweep signal SW to the sweep signal line SWL. The fourth connection pattern LK4 may apply the first power voltage ELVDD to the first transistor T1. The fifth connection pattern LK5 may connect the first transistor T1 and the eighth transistor T8. The sixth connection pattern LK6 may connect the first transistor T1 and the light-emitting element EE. The seventh connection pattern LK7 may apply the sweep signal SW to the sweep signal line SWL. The eighth connection pattern LK8 may connect the eighth transistor T8 and the first transistor T1. The ninth connection pattern LK9 may connect the sweep capacitor CSW and the eighth transistor T8. The tenth connection pattern LK10 may connect the eighth transistor T8 and the ninth transistor T9. The eleventh connection pattern LK11 may apply the pulse width modulation data voltage PWVDATA to the ninth transistor T9. The twelfth connection pattern LK12 may apply the first power voltage ELVDD to the eighth transistor T8. The thirteenth connection pattern LK13 may apply the write signal GW to the eighth transistor T8.

Referring to FIG. 11 to FIG. 16, the display device may further include a third conductive layer CL3

The third conductive layer CL3 may be located on the second conductive layer CL2. For example, a fourth insulating layer may be located on the second conductive layer CL2, and the third conductive layer CL3 may be located on the fourth insulating layer.

The third conductive layer CL3 may include first to third output patterns OT1, OT2, and OT3. The first output pattern OT1 may apply the sweep signal SW to the sweep signal line SWL. The second output pattern OT2 may connect the first transistor T1 and the light-emitting element EE. The third output pattern OT3 may apply the pulse width modulation data voltage PWVDATA to the ninth transistor T9.

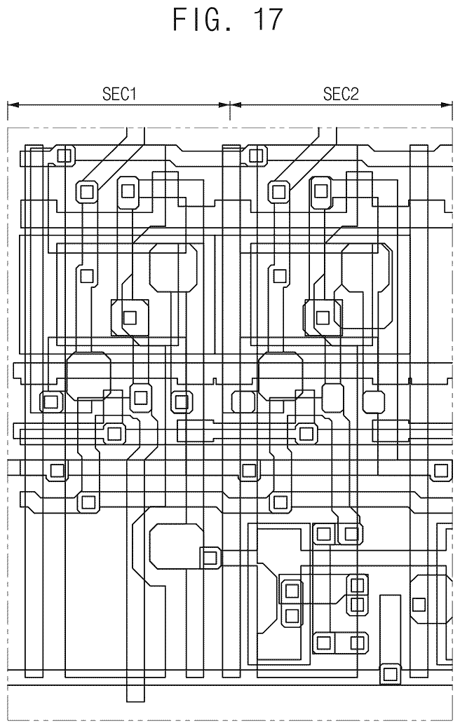

FIG. 17 is a layout diagram showing the display device of FIG. 1.

Referring to FIG. 12 to FIG. 17, the display device may further include a plurality of contact holes. In an area where the plurality of contact holes overlap, the active layer AC, the first conductive layer CL1, the eighth transistor formation layer T8F, the second conductive layer CL2, and the third conductive layer CL3 may be connected.

The structure of the pixel circuit block 110A may be consistent with the structure of the sweep signal generator 710. Additionally, the pixel circuit block 110A and the sweep signal generator 710 may be formed together. Accordingly, the dead space of the display device may be reduced effectively.

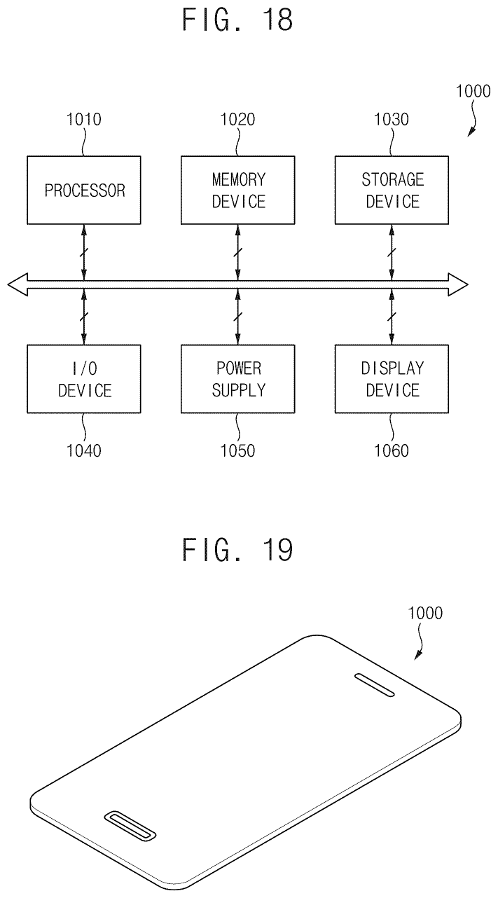

FIG. 18 is a block diagram illustrating an electronic device 1000 according to one or more embodiments of the present disclosure. FIG. 19 is a diagram illustrating an example in which the electronic device of FIG. 18 is implemented as a smart phone.

Referring to FIG. 18 and FIG. 19, the electronic device 1000 may include a processor 1010, a memory device 1020, a storage device 1030, an input/output (I/O) device 1040, a power supply 1050, and a display device 1060. Here, the display device 1060 may be the display apparatus of FIG. 1. Additionally, the electronic device 1000 may further include a plurality of ports for communicating with a video card, a sound card, a memory card, a universal serial bus (USB) device, other electronic device, etc.

In one or more embodiments, as illustrated in FIG. 19, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head-mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, an app-on signal and the input control signal CONT to the driving controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

The display apparatus according to the embodiments may be applied to a display apparatus included in a computer, a notebook, a mobile phone, a smart phone, a smart pad, a PMP, a PDA, an MP3 player, or the like.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

1 what is claimed is:

1. A display device comprising:
a display panel comprising a pixel, and a sweep signal generator configured to generate a sweep signal;
a data driver configured to apply a pixel data voltage, a sweep data voltage, and a pulse width modulation data voltage to the display panel;
a gate driver configured to output a write signal, a pulse width modulation write signal, an initialization signal, and a light-emitting element initialization signal; and
an emission driver configured to apply an emission signal to the display panel,
wherein the pixel comprises:
a light-emitting element;
a pixel circuit block configured to apply a driving current to the light-emitting element in response to the pixel data voltage and the pulse width modulation write signal, and having a structure that is consistent with a structure of the sweep signal generator; and
a pulse width modulation block configured to apply the pulse width modulation write signal to the pixel circuit block based on the pulse width modulation write signal, the sweep signal from the sweep signal generator, and the pulse width modulation data voltage.

2. The of display device claim 1, wherein the pixel circuit block comprises:
a first transistor comprising a control electrode connected to a first node, a first electrode connected to a second node, and a second electrode connected to a third node;
a second transistor comprising a control electrode for receiving the write signal, a first electrode for receiving the pixel data voltage, and a second electrode connected to the second node; and
a fifth transistor comprising a control electrode for receiving the emission signal, a first electrode for receiving a first power voltage, and a second electrode connected to the second node, and
wherein the pulse width modulation block comprises:
an eighth transistor comprising a control electrode connected to a fifth node, a first electrode for receiving the first power voltage, and a second electrode connected to the control electrode of the first transistor; and
a ninth transistor comprising a control electrode for receiving the pulse width modulation write signal, a first electrode for receiving the pulse width modulation data voltage, and a second electrode connected to the fifth node.

3. The display device of claim 2, wherein the first transistor comprises a P-type transistor, and the eighth transistor comprises an N-type transistor.

4. The display device of claim 2, wherein the sweep signal is configured to be increased from a sweep low level to a sweep high level when the emission signal has an activation level.

5. The display device of claim 2, wherein the pulse width modulation write signal comprises the write signal.

6. The display device of claim 2, wherein the pulse width modulation block further comprises a sweep capacitor connected to the sweep signal generator.

7. The display device of claim 6, wherein the sweep signal generator comprises:
a tenth transistor configured to apply the first power voltage to the sweep capacitor;
an eleventh transistor configured to apply the sweep data voltage to the tenth transistor in response to the write signal; and
a fourteenth transistor configured to apply the first power voltage to the tenth transistor in response to the emission signal.

8. The display device of claim 2, wherein the pixel circuit block further comprises:
a third transistor connected to the first node and the third node;
a fourth transistor configured to apply a first initialization voltage to the first transistor in response to the initialization signal;
a sixth transistor configured to apply the driving current to the light-emitting element in response to the emission signal;
a seventh transistor configured to apply a second initialization voltage to an anode of the light-emitting element in response to the light-emitting element initialization signal; and
a first storage capacitor configured to store a voltage of the first node.

9. The display device of claim 8, wherein the second initialization voltage and the first initialization voltage are substantially equal.

10. The display device of claim 8, wherein the eighth transistor comprises a control electrode connected to the fifth node, a first electrode for receiving the first power voltage, and a second electrode connected to the control electrode of the first transistor, and
wherein the ninth transistor comprises a control electrode for receiving the pulse width modulation write signal, a first electrode for receiving the pulse width modulation data voltage, and a second electrode connected to the fifth node.

11. The display device of claim 10, wherein the eighth transistor comprises an N-type transistor.

12. The display device of claim 1, wherein the pixel circuit block comprises:
a first transistor comprising a control electrode connected to a first node, a first electrode connected to a second node, and a second electrode connected to a third node;
a second transistor comprising a control electrode for receiving the write signal, a first electrode for receiving the pixel data voltage, and a second electrode connected to the second node;
a third transistor comprising a control electrode for receiving the write signal, a first electrode connected to the third node, and a second electrode connected to the first node;
a fourth transistor comprising a control electrode for receiving the initialization signal, a first electrode for receiving a first initialization voltage, and a second electrode connected to the first node;
a fifth transistor comprising a control electrode for receiving the emission signal, a first electrode for receiving a first power voltage, and a second electrode connected to the second node;
a sixth transistor comprising a control electrode for receiving the emission signal, a first electrode connected to the third node, and a second electrode connected to a fourth node;
a seventh transistor comprising a control electrode for receiving the light-emitting element initialization signal, a first electrode for receiving a second initialization voltage, and a second electrode connected to the fourth node; and
a first storage capacitor comprising a first electrode for receiving the first power voltage, and a second electrode connected to the first node,
wherein the pulse width modulation block comprises:
an eighth transistor comprising a control electrode connected to a fifth node, a first electrode for receiving the first power voltage, and a second electrode connected to the first node;
a ninth transistor comprising a control electrode for receiving the pulse width modulation write signal, a first electrode for receiving the pulse width modulation data voltage, and a second electrode connected to the fifth node; and
a sweep capacitor comprising a first electrode connected to the sweep signal generator, and a second electrode connected to the fifth node, and
wherein the sweep signal generator comprises:
a tenth transistor comprising a control electrode connected to a sixth node, a first electrode connected to a seventh node, and a second electrode connected to an eighth node;
an eleventh transistor comprises a control electrode for receiving the write signal, a first electrode for receiving the sweep data voltage, and a second electrode connected to the seventh node;
a twelfth transistor comprising a control electrode for receiving the write signal, a first electrode connected to the eighth node, and a second electrode connected to the sixth node;
a thirteenth transistor comprising a control electrode for receiving the initialization signal, a first electrode for receiving the first initialization voltage, and a second electrode connected to the sixth node;
a fourteenth transistor comprising a control electrode for receiving the emission signal, a first electrode for receiving the first power voltage, and a second electrode connected to the seventh node;
a fifteenth transistor comprising a control electrode for receiving the emission signal, a first electrode connected to the eighth node, and a second electrode connected to a ninth node;
a sixteenth transistor comprising a control electrode for receiving the light-emitting element initialization signal, a first electrode for receiving the second initialization voltage, and a second electrode connected to the ninth node; and
a second storage capacitor comprising a first electrode for receiving the first power voltage, and a second electrode connected to the sixth node.

13. The display device of claim 12, wherein the second initialization voltage is substantially equal to the first initialization voltage.

14. The display device of claim 12, wherein the pulse width modulation signal is the write signal.

15. The display device of claim 1, wherein the display panel further comprises first to N-th pixel-rows and first to N-th sweep signal generators, N being a positive integer,
wherein the first pixel-row and the first sweep signal generator are at a same row, and
wherein the N-th pixel-row and the N-th sweep signal generator are at a same row.

16. A sweep signal generator comprising:
a tenth transistor configured to output a first power voltage to a sweep signal line;
an eleventh transistor configured to apply a sweep data voltage to the tenth transistor in response to a write signal; and
a fourteenth transistor configured to apply the first power voltage to the tenth transistor in response to an emission signal.

17. The sweep signal generator of claim 16, wherein the sweep signal generator further comprises:
a twelfth transistor connected to a control electrode of the tenth transistor, and to a second electrode of the tenth transistor;
a thirteenth transistor configured to apply a first initialization voltage to the tenth transistor in response to an initialization signal;
a fifteenth transistor configured to output the first power voltage to the sweep signal line in response to the emission signal;
a sixteenth transistor configured to apply a second initialization voltage to the sweep signal line in response to a light-emitting element initialization signal; and
a second storage capacitor comprising a first electrode for receiving the first power voltage, and a second electrode connected to the control electrode of the tenth transistor.

18. The sweep signal generator of claim 17, wherein the light-emitting element initialization signal is substantially equal to the initialization signal.

19. The sweep signal generator of claim 16, comprising:
the tenth transistor comprising a control electrode connected to a sixth node, a first electrode connected to a seventh node, and a second electrode connected to an eighth node;
the eleventh transistor comprising a control electrode for receiving the write signal, a first electrode for receiving the sweep data voltage, and a second electrode connected to the seventh node;
a twelfth transistor comprising a control electrode for receiving the write signal, a first electrode connected to the eighth node, and a second electrode connected to the sixth node;
a thirteenth transistor comprising a control electrode for receiving an initialization signal, a first electrode for receiving a first initialization voltage, and a second electrode connected to the sixth node;
the fourteenth transistor comprising a control electrode for receiving the emission signal, a first electrode for receiving the first power voltage, and a second electrode connected to the seventh node;
a fifteenth transistor comprising a control electrode for receiving the emission signal, a first electrode connected to the eighth node, and a second electrode connected to a ninth node;
a sixteenth transistor comprising a control electrode for receiving a light-emitting element initialization signal, a first electrode for receiving a second initialization voltage, and a second electrode connected to the ninth node; and
a second storage capacitor comprising a first electrode for receiving the first power voltage, and a second electrode connected to the sixth node.

20. An electronic device comprising:
a display panel comprising a pixel, and a sweep signal generator configured to generate a sweep signal;
a data driver configured to apply a pixel data voltage, a sweep data voltage, and a pulse width modulation data voltage to the display panel;
a gate driver configured to output a write signal, a pulse width modulation write signal, an initialization signal, and a light-emitting element initialization signal; and
an emission driver configured to apply an emission signal to the display panel,
wherein the pixel comprises:
a light-emitting element;
a pixel circuit block configured to apply a driving current to the light-emitting element in response to the pixel data voltage and the pulse width modulation write signal, and having a structure that is consistent with a structure of the sweep signal generator; and
a pulse width modulation block configured to apply the pulse width modulation write signal to the pixel circuit block based on the pulse width modulation write signal, the sweep signal from the sweep signal generator, and the pulse width modulation data voltage.
